(19) United States
(12) Patent Application Publication
(10) Pub. No.: US 2007/0216070 A1
(43) Pub. Date: Sep. 20, 2007

(54) Method of forming multi-component instrument panel skin using negative vacuum forming

(75) Inventor: Dennis Dutouquet, Thumeries (FR)

Correspondence Address: VISTEON, C/O BRINKS HOFER GILSON & LIONE, PO BOX 10395, CHICAGO, IL, 60610, US

(73) Assignee: Visteon Global Technologies, Inc.

(21) Appl. No.: 11/375,943

(22) Filed: Mar. 15, 2006

(51) Int. Cl. B29C 51/00

(52) U.S. Cl. 264/510; 264/544

(57) ABSTRACT

A method of forming a multi-component skin for an instrument panel assembly includes providing a negative vacuum forming tool adapted to form an instrument panel skin into a predetermined shape; providing a skin element, made from a first material, placing the skin element within the negative vacuum forming tool and securing the skin element therein; providing an instrument panel skin, made from a second material, heating the instrument panel skin, and placing the instrument panel skin within the negative vacuum forming tool, on top of the skin element; activating the negative vacuum forming tool to suck the instrument panel skin against the negative vacuum forming tool, wherein the instrument panel skin molds to the shape of the negative vacuum forming tool and around the skin element; and allowing the instrument panel skin and the skin element to cool and removing the multi-component instrument panel skin from the negative vacuum forming tool.

### BACKGROUND

1. Field of the Invention

The invention relates generally to a method of forming a multi-component instrument panel skin covering using a negative vacuum forming process.

2. Related Technology

In prior art instrument panel skins, if a two-tone or multi-colored skin or multi-component skin was desired, it was necessary to somehow connect two different pieces of differently colored skin material together. Unfortunately, known methods of joining or attaching two pieces of skin material generally leave some visible seam or groove at the point of attachment. With modern “fit and finish” requirements, this seam or groove must be minimized or eliminated. Further, any joint or connection between two separate pieces of skin material can have the possibility of coming apart.

Therefore, there is a need for a process of forming a two-tone or multi-colored or multi-component instrument panel skin that will provide minimal or no visible seam or groove within the skin, a flush surface between the different colored sections of the skin, and is robust against the possibility of the differently colored sections coming apart.

### SUMMARY

In overcoming the above limitations and other drawbacks, a method of forming a multi-colored or multi-component skin for an instrument panel assembly includes the steps of providing a negative vacuum forming tool adapted to form an instrument panel skin into a predetermined shape. Providing at least one skin element, being made from a first material, and placing the skin element within the negative vacuum forming tool. The skin element is secured within the negative vacuum forming tool. An instrument panel skin, made from a second material is provided. The instrument panel skin is heated and placed within the negative vacuum forming tool, on top of the skin element. The negative vacuum forming tool is activated to suck the instrument panel skin against the negative vacuum forming tool, wherein the instrument panel skin molds to the shape of the negative vacuum forming tool and around the skin element. The instrument panel skin and the skin element are allowed to cool and the multi-component instrument panel skin is removed from the negative vacuum forming tool.

In one aspect, providing at least one skin element, made from a first material, includes thermoforming at least one skin element, made from a first material; applying adhesive to a rear side of the skin element; and cutting the skin element to a predetermined shape.

In another aspect, thermoforming at least one skin element, made from a first material, includes thermoforming at least one skin element, made from a first material, by one of a negative vacuum forming process and a positive vacuum forming process.

In still another aspect, applying adhesive to a rear side of the skin element, includes applying a heat activated adhesive that activates at a temperature above forty degrees Celsius to a rear side of the skin element.

In yet another aspect, providing an instrument panel skin, made from a second material, heating the instrument panel skin, and placing the instrument panel skin within the negative vacuum forming tool, on top of the at least one skin element includes providing an instrument panel skin, made from a second material, heating the instrument panel skin to a temperature between about one-hundred and sixty degrees Celsius and about two-hundred and forty degrees Celsius, and placing the instrument panel skin within the negative vacuum forming tool, on top of the at least one skin element, such that the instrument panel skin forms to the shape of the negative vacuum forming tool and around the skin element.

In still another aspect, the temperature of the negative vacuum forming tool, the instrument panel skin, and the skin element is regulated at a temperature above forty degrees Celsius for a predetermined amount of time to insure that the heat activated adhesive on the rear side of the skin element is activated.

In yet another aspect, providing an instrument panel skin, made from a second material, heating the instrument panel skin, and placing the instrument panel skin within the negative vacuum forming tool, on top of the at least one skin element, includes providing an instrument panel skin, made from a second material, heating the instrument panel skin, and placing the instrument panel skin within the negative vacuum forming tool such that the edge of the instrument panel skin overlaps the edge of the skin element, thereby defining a gluing ring.

Further objects, features and advantages of this invention will become readily apparent to persons skilled in the art after a review of the following description, with reference to the drawings and claims that are appended to and form a part of this specification.

### BRIEF DESCRIPTION OF THE DRAWINGS

FIG. 1 is a side sectional view of a multi-component instrument panel skin formed in accordance with the method of the present invention;

FIG. 2 is a side sectional view of a negative vacuum forming tool wherein the skin element has been placed within the tool, and an instrument panel skin is being placed within the tool on top of the skin element;

FIG. 3 is a side sectional view of the negative vacuum forming tool with the skin element placed therein and the instrument panel skin positioned within the tool on top of the skin element;

FIG. 4 is a side sectional view of a skin element being thermoformed in a negative vacuum forming mold;

FIG. 5 is a side sectional view of the skin element after being placed within the negative vacuum forming mold;

FIG. 6A is a side sectional view of the skin element as a heat activated adhesive is applied to a rear surface thereof;

FIG. 6B is a side sectional view of the skin element as the skin element is cut to shape; and

FIG. 7 is a side sectional view of a multi-component skin having a skin element and an instrument panel skin that overlaps the skin element.

### DETAILED DESCRIPTION

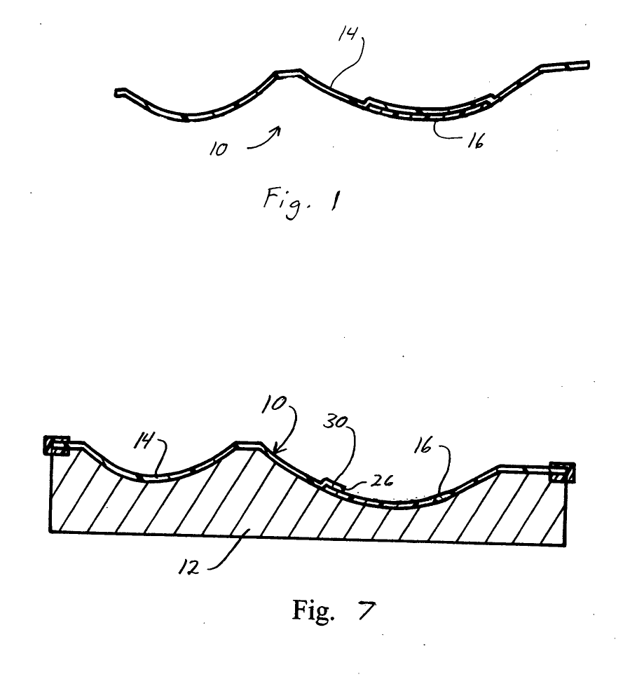

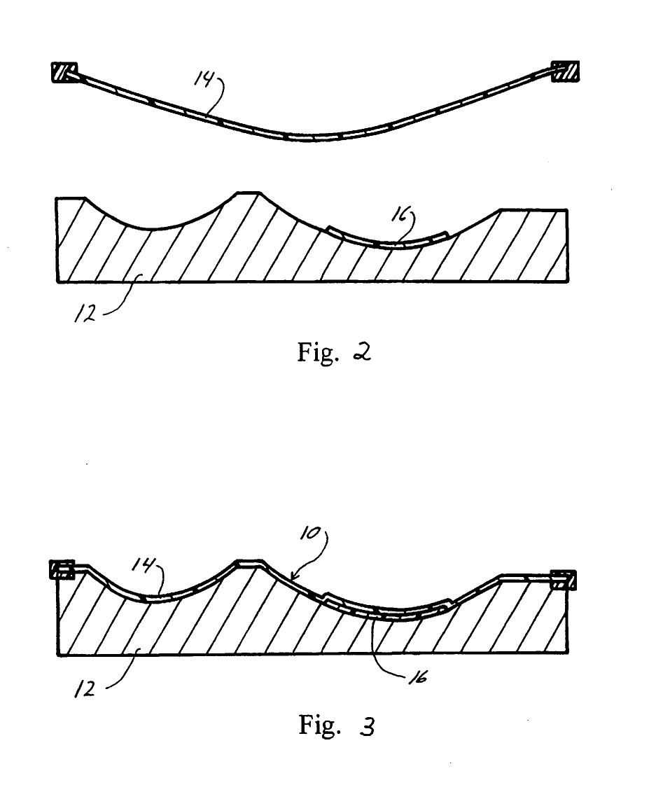

Referring to FIG. 1, a multi-component skin for an instrument panel is shown generally at 10. The method of forming the multi-component skin 10 is outlined herein. Referring to FIG. 2, a negative vacuum forming tool 12 is provided. The vacuum forming tool 12 is adapted to form an instrument panel skin 14 into a predetermined shape. A skin element 16 is placed within the negative vacuum forming tool 12, and is secured therein. The skin element 16 is made from a first material, and preferably has a first color. The instrument panel skin 14 is provided that is made from a second material that may or may not be the same color as the first material of the skin element 16. The materials used for the instrument panel skin 14 and the skin element 16 can be any appropriate materials for the application, including but not limited to polyolefins, polyurethane, PVC, textile composites, and leather.

The instrument panel skin 14 is heated, and placed within the negative vacuum forming tool 12, on top of the skin element 16, as shown in FIGS. 2 and 3. The negative vacuum forming tool 12 is then activated, wherein the instrument panel skin 14 is drawn against the negative vacuum forming tool 12 such that the instrument panel skin 14 molds to the shape of the negative vacuum forming tool 12 and around the skin element 16, as shown in FIG. 3. The instrument panel skin 14 and the skin element 16 are then allowed to cool and are removed from the negative vacuum forming tool 12, thereby formed into a multi-component instrument panel skin 10, as shown in FIG. 1.

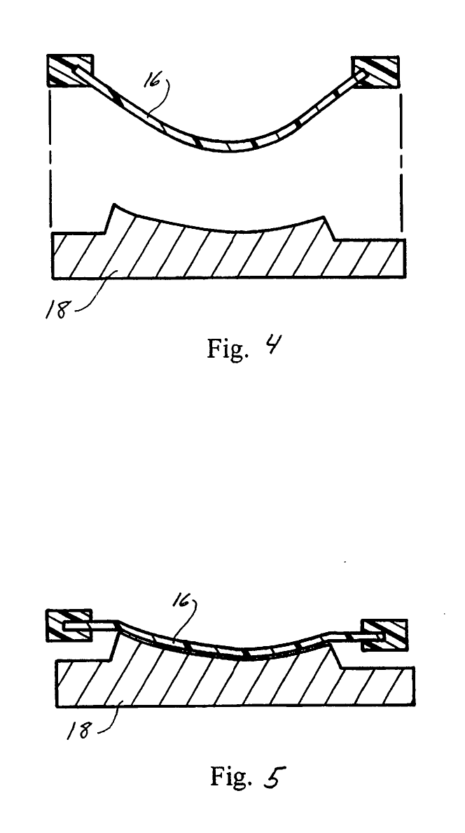

The skin element 16 is preferably thermoformed in either a positive or negative vacuum forming tool. Referring to FIGS. 4 and 5, the skin element 16 is placed within a negative vacuum forming tool 18 similar to the negative vacuum forming tool 12 in which the multi-component instrument panel skin 10 is eventually formed. The skin element 16 is secured in place and the negative vacuum forming tool 18 is activated, wherein the skin element 16 is formed to a specific shape.

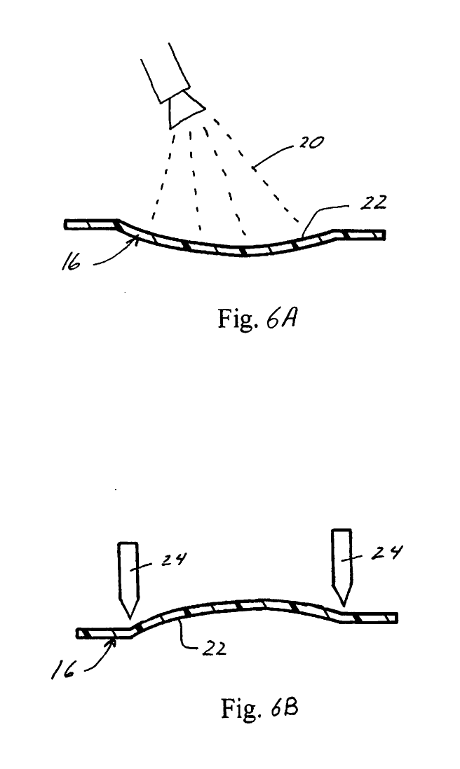

After the skin element 16 has been formed in the negative vacuum forming tool 18, the skin element 16 is removed and a coating of adhesive 20 is applied to a rear surface 22 of the skin element 16, as shown in FIG. 6A. The adhesive can be present on the back side of the skin element before the thermoforming process. Preferably, the adhesive 20 is a heat-activated adhesive 20 that activates at a temperature above about forty degrees Celsius. The adhesive 20 will assist in bonding the skin element 16 to the instrument panel skin 14 when the two are molded together in the negative vacuum forming tool 12. After the adhesive 20 has been applied to the rear surface 22 of the skin element 16, the skin element 16 is cut to a final shape, as shown in FIG. 6B. As shown, the skin element 16 is being cut by knives 24, however, the skin element 16 could be cut by a drill or a laser or any other suitable cutting means.

After the skin element 16 is formed, adhesive 20 has been applied, and the skin element 16 is cut to shape, the skin element 16 is placed within the negative vacuum forming tool 12 as shown in FIG. 2. The skin element 16 can be secured within the negative vacuum forming tool 12 by either mechanical means or by the vacuum effect from the negative vacuum forming tool 12.

Prior to being placed within the negative vacuum forming tool 12, the instrument panel skin 14 is heated to a temperature between about one-hundred and sixty degrees Celsius and about two-hundred and forty degrees Celsius. This makes the instrument panel skin 14 soft, thereby allowing the instrument panel skin 14 to mold to the contour of the negative vacuum forming tool 12 and to bond to the skin element 16.

Once the instrument panel skin 14 has been placed within the negative vacuum forming tool 12, the temperature of the negative vacuum forming tool 12, the instrument panel skin 14, and the skin element 16 are maintained at a temperature above about forty degrees Celsius for a predetermined amount of time. This insures that the heat activated adhesive 20 on the rear surface 22 of the skin element 16 will activate, thereby bonding the rear surface 22 of the skin element 16 to the instrument panel skin 14. Additionally, the adhesive 20 may be heated prior to the skin element 16 being placed within the tool 12. A heat source such as an infra-red lamp may be used to heat the rear surface 22 of the skin element 16 prior to placing the skin element 16 within the tool 12.

Referring to FIG. 7, in another embodiment, the skin element 16 is placed within the negative vacuum forming tool 12 such that when the instrument panel skin 14 is placed within the negative vacuum forming tool 12, the edge 26 of the instrument panel skin 14 overlaps the skin element 16, thereby defining a gluing ring 30. It is advantageous for the edge 26 of the instrument panel skin 14 to overlap the skin element 16 by approximately twenty millimeters.

It is therefore intended that the foregoing detailed description be regarded as illustrative rather than limiting, and that it be understood that it is the following claims, including all equivalents, that are intended to define the spirit and scope of this invention.

What is claimed is:

1. A method of forming a multi-component skin for an instrument panel assembly comprising:
providing a negative vacuum forming tool adapted to form an instrument panel skin into a predetermined shape;
providing at least one skin element, being formed from a first material, and placing the at least one skin element within the negative vacuum forming tool;
securing the at least one skin element within the negative vacuum forming tool;
providing an instrument panel skin, being formed from a second material, heating the instrument panel skin, and placing the instrument panel skin within the negative vacuum forming tool, on top of the at least one skin element;
activating the negative vacuum forming tool to suck the instrument panel skin against the negative vacuum forming tool, wherein the instrument panel skin molds to the shape of the negative vacuum forming tool and around the skin element; and
allowing the instrument panel skin and the skin element to cool and removing the multi-component instrument panel skin from the negative vacuum forming tool.

2. The method of claim 1 wherein providing at least one skin element, made from a first material, comprises:
thermoforming at least one skin element that is made from a first material; and
cutting the skin element to a predetermined shape.

3. The method of claim 2, further including applying an adhesive to a rear side of the skin element prior to cutting the skin element to a predetermine shape.

4. The method of claim 3 wherein thermoforming at least one skin element, comprises thermoforming at least one skin element, by one of a negative vacuum forming process and a positive vacuum forming process.

5. The method of claim 3 wherein the adhesive, comprises a heat activated adhesive.

6. The method of claim 5 wherein the heat activated adhesive activates at a temperature greater than forty degrees Celsius.

7. The method of claim 3 wherein cutting the skin element to a predetermine shape, comprises cutting the skin element to a predetermine shape using one of a knife, a drill, a lazer, a water jet, and an integrated feature within the skin tool.

8. The method of claim 3 wherein activating the negative vacuum forming tool to suck the instrument panel skin against the negative vacuum forming tool, wherein the instrument panel skin molds to the shape of the negative vacuum forming tool and around the skin element, includes regulating the temperature of the negative vacuum forming tool, the instrument panel skin, and the skin element at a temperature greater than forty degrees Celsius for a predetermined amount of time to insure that the heat activated adhesive on the rear side of the skin element is activated.

9. The method of claim 8 further including pre-heating the adhesive prior to placing the skin element within the negative vacuum forming tool.

10. The method of claim 9 further including exposing the rear side of the skin element

11. The method of claim 1 wherein securing the at least one skin element within the negative vacuum forming tool comprises securing the at least one skin element within the negative vacuum forming tool with one of mechanical features and vacuum effect from the negative vacuum forming tool.

12. The method of claim 1 wherein providing an instrument panel skin, made from a second material, heating the instrument panel skin, and placing the instrument panel skin within the negative vacuum forming tool, on top of the at least one skin element comprises providing an instrument panel skin, made from a second material, heating the instrument panel skin to a temperature between about one-hundred and sixty degrees Celsius and about two-hundred and forty degrees Celsius, and placing the instrument panel skin within the negative vacuum forming tool, on top of the at least one skin element, such that the instrument panel skin forms to the shape of the negative vacuum forming tool and around the skin element.

13. The method of claim 1 wherein providing an instrument panel skin, made from a first material, heating the instrument panel skin, and placing the instrument panel skin within the negative vacuum forming tool, on top of the at least one skin element, comprises providing an instrument panel skin, made from a second material, heating the instrument panel skin, and placing the instrument panel skin within the negative vacuum forming tool such that the instrument panel skin extends partially on top of the at least one skin element.

14. The method of claim 13, wherein when the instrument panel skin is placed on top of the skin element, the edge of the instrument panel skin overlaps the edge of the skin element, thereby defining a gluing ring.

15. The method of claim 14, wherein the edge of the instrument panel skin overlaps the edge of the skin element by approximately twenty millimeters.
